(19) United States
(12) Patent Application Publication
(10) Pub. No.: US 2026/0320636 A1
(43) Pub. Date: Oct. 15, 2026

(54) SYSTEM AND METHOD FOR GENERATING MARKETING CONCEPTS BASED ON ACTIVATION OF DEEP LEARNING LARGE LANGUAGE MODELS

(71) Applicant: MKHSTRY AI, LLC, Rocky River, OH (US)

(72) Inventors: Jeffrey Charney, Rocky River, OH (US); Austin Wilson, Lakewood, OH (US); Nithin Cherian, Chesterland, OH (US); Ethan Kahl, Avon Lake, OH (US)

(21) Appl. No.: 19/179,290

(22) Filed: Apr. 15, 2025

(51) Int. Cl. G06Q 30/0204; G06N 20/00

(52) U.S. Cl. CPC G06Q 30/0204; G06N 20/00

(57) ABSTRACT

A method for generating marketing concepts includes steps: (a) extracting data from at least one of a client-provided structured data source, a client-provided unstructured data source, internet data, and a marketing database; (b) storing the extracted data in at least one of a concepts store, a company context pools store, and a product context pools store; (c) creating a user persona representing traits of a segment of a target audience of the marketing concepts based on the stored data; (d) identifying a problem faced by the segment represented by the user persona; and (e) creating a marketing concept based on the identified problem; wherein at least a portion of each of steps (a)-(e) is performed by at least one LLM agent running on a computer system.

### BACKGROUND

From the origins of marketing to now, the creative process for developing marketing campaigns have always been inefficient, time-consuming, cumbersome and an occasionally unstructured process. The central component derived from the creative process is the concept, which can take upwards of 6 to 9 months to develop. The development of the creative concept—which is much broader and long-lasting than the executional creative content—is the first and most important step in driving overall marketing campaign launch and development. The conceptual development process relies heavily on intuition, past experiences, and several brainstorming sessions to hone in on a couple impactful campaign concepts.

Historically, a company or individual seeks out creative agencies and media buying firms to research, develop strategies and relevant creative ideas, produce creative content for a variety of potential outlets, then identify and purchase ad space on the relevant media channels. Such channels include, but not limited to, print, radio, TV, outdoor, digital, social, and influencer channels. Once deployed, these campaigns would be analyzed for effectiveness relative to their goals.

With the advances made in artificial intelligence (AI), specifically Large Language Models (LLMs), we can now implement processes assisted by these AI tools to generate impactful creative concepts and outputs for campaigns of any scope from small local advertisements to large-scale multi-media campaigns.

### SUMMARY

Natural language understanding (NLU) and deep learning techniques for training a machine-learning/artificial intelligence model may address the foregoing and other problems with creating impactful computer-generated content. A system may ingest multivariate data having unstructured content from various sources and sorted into multiple stores of information. The ingested multivariate data may include previously generated documents, unstructured internet documents and data from marketing databases.

Data is collected via structured documents completed by the client to obtain a primary data set required to develop what is referred to as the strategic or creative brief. The system may train and execute a deep-learning model to identify and classify each of the sections according to a respective label. To train the machine-learning model (MLM) the system may divide a subset of documents to be annotated by humans who will assign labels to identified sections within each document to be sorted into context pools. The sorted data is sanitized and updated as required to reflect evolving market identity, then used to train the model for generating insights and content suggestions.

To fully populate the context pools, multiple artificial intelligence (AI) agents are deployed to coordinate, identify, and obtain additional data as required from databases, the internet, core client data, etc. until the goal is achieved. These AI agents are powered by artificial intelligence engines that operate independent of human interaction or intervention. These artificial-intelligence-powered AI Agents will be referred to hereinafter as “Agents”.

The data stored in the fully populated context pools are processed by the system to first create a user persona, an archetype embodying key traits of adherent to a target audience. An LLM agent will categorize and clean the data, then delegate work to a series of Feature Extraction Agents to categorize the key insights of a target audience. Another agent will use the categorized data to synthesize user personas. Then this data is validated and refined based on prior data, client feedback, and user testing.

With relevant data cleaned and categorized, the system automates the process of identifying and validating key Problem and Insight for the project via two methods. One method uses context derived from generated user persona, client-defined problem/insight, company context pool, and the product context pool. The other method utilizes an LLM Agent to apply a framework to the client supplied data to systematically identify the problem and insight.

The determined Problem/Insight is formatted by an LLM into a specific semantic format that is expected by the other parts of the system. Then client feedback and prior campaign data is used to finally refine and validate the problem and insight to ensure relevance and accuracy.

The development of an impactful marketing concept integrates the understanding of user personas, identification of problems, derivation of insights, and the application of appropriate tone. The system automates the creation of the concept in a structured manner for use with future processes. The concept synthesis agent utilizes the user persona, problem, insight, and client selected tone as inputs into a LLM trained on creative works, existing concepts to generate a structured output including, but not limited to, Concept Name, Concept Tagline, and Concept Description. These outputs are validated by another LLM Agent trained to act as selected user persona to determine success rate. This data is then refined by feedback from client and prior campaign data.

After the generation of the concepts, our system allows for the augmentation or expansion of selected marketing concepts. The system uses a controller agent to direct six LLM agents in response to client inputs to refine and enhance the marketing concept. User inputs are translated into structured events delegated to the controller agent, which calls on multiple LLM agents to fulfill the task required by the client event. Each agent focuses on specific aspects of the concept to refine like news, relevant influencers, character creation, social media input, name regeneration, tagline regeneration, and description regeneration. The augmented data takes the final marketing concept and the system presents it to the user via an interactive interface that highlights all of the LLM agent generated content.

In accordance with one aspect of the present invention, a method for generating marketing concepts includes the steps of: (a) extracting data from at least one of the following: a client-provided structured data source, a client-provided unstructured data source, internet data, and a marketing database; (b) storing the extracted data in at least one of the following: a concepts store, a company context pools store, and a product context pools store; (c) creating a user persona based on the stored data, wherein the user persona represents traits of a segment of a target audience of the marketing concepts; (d) identifying a problem faced by the segment of the target audience represented by the user persona; and (e) creating a marketing concept based on the identified problem; wherein steps (a)-(e) are performed by a computer system comprising one or more computers, and at least a portion of each of steps (a)-(e) is performed by at least one LLM agent running on the computer system.

In accordance with another aspect of the present invention, a method for generating marketing concepts includes the steps of: (a) extracting data from at least one of the following using one or more data extraction LLM agents: a client-provided structured data source, a client-provided unstructured data source, internet data, and a marketing database; (b) storing the extracted data in at least one of the following: a concepts store, a company context pools store, and a product context pools store; (c) analyzing the stored data to extract a plurality of traits for a segment of a target audience of the marketing concepts using one or more user feature extraction LLM agents; (d) synthesizing the extracted traits into a user persona that represents the segment of the target audience of the marketing concepts using a user persona synthesis LLM agent, and storing the user persona in a user personas store; (e) using the stored data of step (b) or the stored user persona of step (d) to build context for a problem faced by the segment of the target audience represented by the user persona or insight into the problem using structured, natural language; (f) using the built context to synthesize the problem or the insight in natural language using a problem/insight synthesis LLM agent, and storing the synthesized problem or insight in the concepts store; and (g) using the synthesized problem or insight to synthesize a marketing concept in a structured data model using a concept synthesis LLM agent, and storing the marketing concept in the concepts store; wherein steps (a)-(g) are performed by a computer system comprising one or more computers.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, embodiments of which will be described in detail in this specification and illustrated in the accompanying drawings which form a part hereof. Features of the present disclosure may be illustrated by way of example and not limited in the following figures, in which like numerals indicate like elements, in which:

FIG. 1 shows an illustrative system 100 for generating marketing concepts based on a series of deep learning AI language models, according to an implementation.

FIG. 2 shows an example 200 of the ingestion of structured and unstructured data used for context generation for use with a series of deep learning AI language models, according to an implementation.

FIG. 3 shows an example 300 of the automatic synthesis of user personas incorporating a manual feedback loop and activation of multiple user feature extraction agents utilizing a deep learning AI language model, according to an implementation.

FIG. 4 shows an example 400 of the automatic synthesis and/or validation of problem/insight pairs as defined herein, incorporating a manual feedback loop and activation of a deep learning AI language model, according to an implementation.

FIG. 5 shows an example 500 of the automatic synthesis, validation, and refinement of a creative marketing concept as defined herein. This example incorporates an automatic feedback loop and activation of a deep learning AI language model, according to an implementation.

FIG. 6 shows an example 600 of the interactive and assistive augmentation of a creative marketing concept as defined herein. This example incorporates multiple activations of deep learning AI language models, based on events generated from client interaction with the system, according to an implementation.

### DETAILED DESCRIPTION

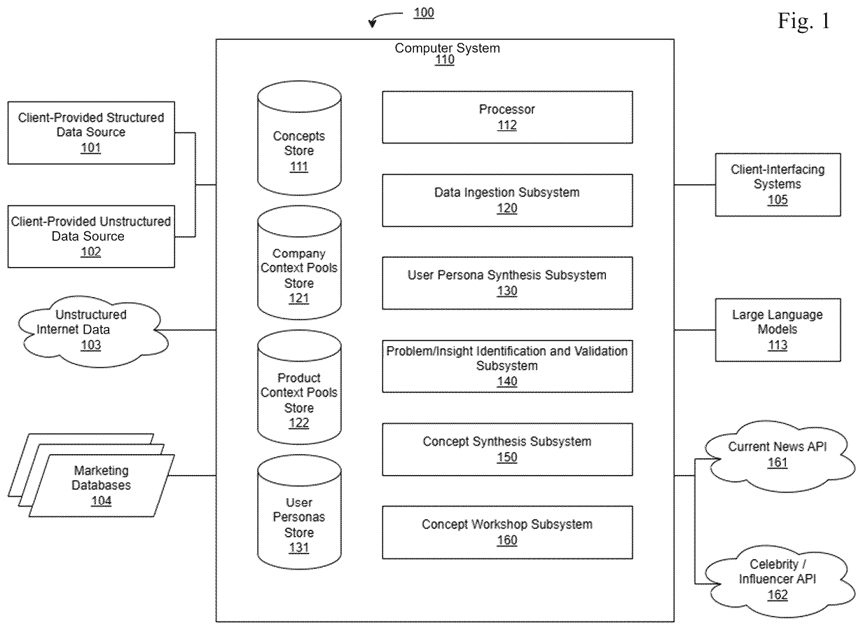

Referring now to the drawings wherein the showings are for purposes of illustrating embodiments of the invention only and not for purposes of limiting the same, and wherein like reference numerals are understood to refer to like components, FIG. 1 shows an illustrative system 100 for automatically generating unique content containing natural language text that satisfies the semantic structure of marketing concepts based on a multi-layer process, according to an implementation. Computer-generated may refer to content or objects that have been created, synthesized, or produced by computer software algorithms rather than by human effort alone. This encompasses a broad spectrum of outputs, including, but not limited to, textual content, digital images, graphics, and animations, music, and virtual environments. The creation process leverages techniques such as procedural generation, where algorithms follow certain rules to automatically produce complex structures, and machine learning, where computers are trained on vast datasets to generate outputs that mimic human-created content.

The system 100 may include at least one Client-Provided Structured Data Source 101, at least one Client-Provided Unstructured Data Source 102 (also referred to as the “Client-Provided Unstructured Documents 102”), an Unstructured Internet Data set 103 (also referred to as the “Unstructured Internet Documents 103”), one or more Marketing Databases 104, one or more Client-Interfacing Systems 105, a Computer System 110, a Concepts Store 111, one or more Large Language Models 113, and/or other components.

The at least one Client-Provided Structured Data Source 101 may store a plurality of structured data points provided by a client through various means. The structured data points may refer to content in a structured format containing natural language, graphics, and/or other content and may include, but not restricted by:

Company Name: Name of the client's company or organization.

Product Name: Name of the client's product or service.

Target Demographic: Including, but not limited to age, gender, activity level, and/or vocation.

Target Psychographic: Including, but not limited to attitude, aspiration, and/or other psychological criteria.

Target Region: Including, but not limited to, city, state, country, and/or region.

Client-Provided Insight: As described herein.

Client-Provided Problem: As described herein.

List of Key Competitors: Including, but not limited to brands, products, technologies, and/or markets.

List of Key Social Media and Digital Channels: Including, but not limited to, social media handles, and/or usernames, video streaming channels, and/or digital platforms.

Marketing Budget: The budget the client has for marketing delivery, as described as a single value, natural language, or other means of descriptor.

Client-Goal Problem: Including, but not limited to Key Point Indicators (KPIs), Net Promoter Score (NPS), Revenue Targets, and/or Market Share targets.

Website: Including, but not limited to, root, microsite, partner site, and/or product detail page.

Keywords: Defined as words that pose a significant role to topics including, but not limited to, client's company identity, client's products, client's services, and/or supplied data.

Client-Provided Additional Details: Including, but not limited to, custom documents, proprietary info, and/or trade secrets.

The at least one Client-Provided Unstructured Data Source 102 may contain a plurality of documents that may be elicited from a client. The unstructured documents may refer to content in an unstructured format containing natural language, graphics, and/or other content. These documents may include, but not restricted by:

Strategic Brief Documents: Documents that include data that assist in describing, but not restricted by, business area of focus, key insight, differentiating factors, and/or primary media channel for campaign.

Auxiliary Documents: Documents that include additional data that assist in further describing any combination of the associated data points as described herein.

The one or more Client-Interfacing Systems 105 may include a plurality user interface systems or physical systems that facilitate the interfacing of a client with the Computer System 110. For example, the one or more Client-Interfacing Systems 105 may include user interface systems accessible by desktop computers, laptop computers, tablet computer, smartphone, and/or other types of devices that may communicate with the Computer System 110.

The Concepts Store 111 may refer to a plurality of states and data generated by any number of the components that make up Computer System 110. This data includes, but is not limited to, a plurality of concept data models, a plurality of structured problem and/or insight data models, and/or any number of additional metadata associated with any number of particular concepts. A concept as identified herein, may be referred to a structured data model that may include, but not restricted by:

Concept Name: The identity of the marketing initiative, offering a memorable label that encapsulates the essence and purpose of the concept. It should be unique, catchy, and reflective of the concept's goals or the product's/features being promoted.

Concept Tagline: A succinct, impactful phrase that accompanies the Concept Name. It further elaborates on the concept by evoking emotions, highlighting benefits, or making a compelling promise. The tagline reinforces the concept's intent and makes it more relatable or memorable to the audience.

Concept Description: This component offers a more detailed exposition of the marketing concept. It explains the concept's relevance, its unique value proposition, the problems it solves, or how it enhances the customer's experience or life. The Concept Description bridges the gap between the audience's needs or desires and the solution provided by the client's product, service, or company. It should be persuasive, engaging, and clearly articulate why the audience should care about the concept.

To address the foregoing and other issues, the Computer System 110 may include at least one Processor 112 and/or other components. The Processor 112 may include one or more of a digital processor, an analog processor, a digital circuit designed to process information, an analog circuit designed to process information, a state machine, and/or other mechanisms for electronically processing information. Although the Processor 112 is shown in FIG. 1 as a single entity, this is for illustrative purposes only. In some implementations, the Processor 112 may include a plurality of processing units. These processing units may be physically located within the same device, or the Processor 112 may represent processing functionality of a plurality of devices operating in coordination.

As shown in FIG. 1, the Processor 112 is programmed to execute one or more computer program components. The computer program components may include software programs and/or algorithms coded and/or otherwise embedded in the Processor 112, for example. The one or more computer program components or features may include various subsystems such as a Data Ingestion Subsystem 120 (also referred to as the “Data Gathering System 120”), a User Persona Synthesis Subsystem 130 (also referred to as the “User Persona Synthesis Module 130”), a Problem/Insight Identification and Validation Subsystem 140, a Concept Synthesis Subsystem 150, a Concept Workshop Subsystem 160, and/or other components.

The Processor 112 may be configured to execute or implement the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160 by software; hardware; firmware; some combination of software, hardware, and/or firmware; and/or other mechanisms for configuring processing capabilities on the Processor 112. It should be appreciated that although the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160 are illustrated in FIG. 1 as being co-located in the Computer System 110, one or more of the components or features of the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160 may be located remotely from the other components or features. The description of the functionality provided by the different components or features of the Data Ingestion Subsystem 120, the User Persona Synthesis Subsystem 130, and the Problem/Insight Identification and Validation Subsystem 140, described below is for illustrative purposes, and is not intended to be limiting, as any of the components or features of the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160 may provide more or less functionality than is described, which is not to imply that other descriptions are limiting. For example, one or more of the components or features of the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160 may be eliminated, and some or all of its functionality may be provided by other components or features of the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160, again which is not to imply that other descriptions are limiting. As another example, the Processor 112 may include one or more additional components that may perform some or all of the functionality attributed below to one of the components or features of the Data Ingestion Subsystem 120, the User Persona Synthesis Subsystem 130, the Problem/Insight Identification and Validation Subsystem 140, the Concept Synthesis Subsystem 150, and the Concept Workshop Subsystem 160.

### Data Ingestion Subsystem

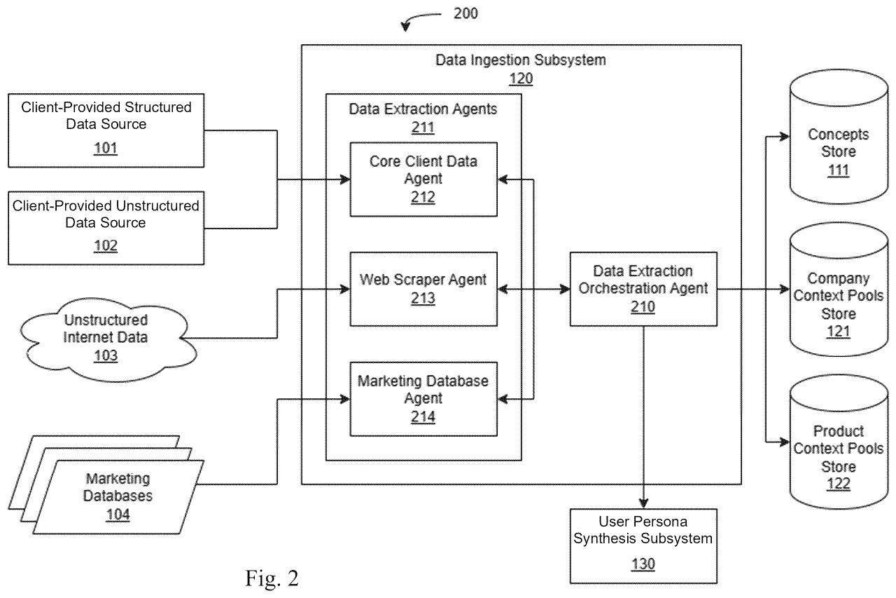

The Data Ingestion Subsystem 120 may obtain structured and unstructured data through various forms of manual and automatic data ingestion. For example, the Data Ingestion Subsystem 120 may use one or more Data Extraction Agents 211 to extract structured and unstructured data from the at least one Client-Provided Structured Data Source 101, the at least one Client-Provided Unstructured Data Source 102, the Unstructured Internet Data set 103 and/or the one or more Marketing Databases 104. The Data Ingestion Subsystem 120 may store extracted data in the Concepts Store 111, a Company Context Pools Store 121 (also referred to as a “Company Context Pool 121”), and/or a Product Context Pools Store 122 (also referred to as a “Product Context Pool 122”). A more detailed example of the Data Ingestion Subsystem 120 will be described with reference to FIG. 2.

The Company Context Pools Store 121 may refer to a data store that encapsulates a company's marketable identity. The datastore contains structured and unstructured data detailing corporate attributes, products, services, brand elements, historical milestones, culture and ethics. Structured data comprises factual information like including brand names, trademarks, taglines, marketing campaign content, product and service descriptions, customer interaction transcripts, market analysis reports, and competitive landscape assessments. Unstructured data includes textual content from press releases, social media activities, marketing materials, corporate identity manuals/style guides, corporate responsibility reports, and customer feedback.

The Product Context Pools Store 122 may refer to a data store that stores a specific product's marketable identity. The datastore contains structured and unstructured data datasets detailing product specifications, brand values, target demographics, user engagement metrics, and competitive positioning. This pool incorporates qualitative content such as customer reviews, social media sentiment analysis, and marketing campaign narratives. Quantitative data includes sales figures, market share statistics, and spend efficiency across all traditional advertising and digital channels.

Both the Company Context Pools Store 121 and the Product Context Pools Store 122 datasets may be sanitized for confidentiality, retaining relevance and specificity to ensure the model accurately aligns generated content with the company's brand voice, values, culture, and operational context, enhancing coherence in automated content creation, and other AI-driven textual applications. Additionally both datasets are periodically updated to reflect the evolving marketable identity and to train the model for generating insights, content suggestions, and interactive responses that align with the company's branding strategy and market positioning objectives.

The Data Ingestion Subsystem 120 may use a Data Extraction Orchestration Agent 210 to extract data from the at least one Client-Provided Structured Data Source 101, the at least one Client-Provided Unstructured Data Source 102, the Unstructured Internet Data set 103 and/or the one or more Marketing Databases 104. The one or more Data Extraction Agent 211 may refer to an agent that implements a single model from the set of the one or more Large Language Models 113. The Data Extraction Orchestration Agent 210 may be responsible for delegating tasks to the one or more Data Extraction Agents 211. The one or more Data Extraction Agents 211 may refer to multiple large language model agents including, but not limited to, a Core Client Data Agent 212, a Web Scraper Agent 213, and a Marketing Database Agent 214.

The Core Client Data Agent 212 may be referred to as an agent that implements a large language model from the set of the one or more Large Language Models 113. The Core Client Data Agent 212 may be responsible for fetching data from the at least one Client-Provided Structured Data Source 101, and/or the at least one Client-Provided Unstructured Data Source 102.

The Web Scraper Agent 213 may be referred to as an agent that implements a large language model from the set of the one or more Large Language Models 113. The Web Scraper Agent 213 may be responsible for fetching data from the Unstructured Internet Data set 103, such as relevant data sourced from a company's website, existing customer feedback and sentiment from the client company's online presence, and/or other internet-based resources.

The Marketing Database Agent 214 may be referred to as an agent that implements a large language model from the set of the one or more Large Language Models 113. The Marketing Database Agent 214 may be responsible for fetching data from the one or more Marketing Databases 104 by means of executing generated queries for a series of marketing databases to identify various quantitative and qualitative data regarding the historical marketing profile for a company.

### User Persona Synthesis Subsystem

A user persona may be a semi-fictional archetype that may represent the key traits of a large segment of a target audience, defined by its demographics, behavior patterns, motivations, goals, and pain points. User personas are crafted on the basis of research to represent different segments of a product's user base or potential customers, thus allowing organizations to tailor their strategies, products, and services to meet the specific needs, expectations, and behaviors of their target audience.

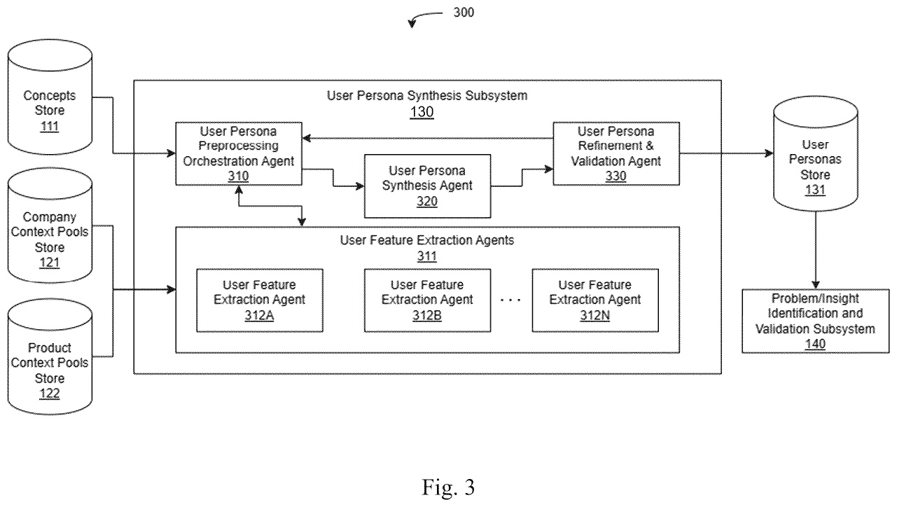

The User Persona Synthesis Subsystem 130 may produce, validate, and store any number of user personas. For example, the User Persona Synthesis Subsystem 130 may obtain information from the Concepts Store 111, the Company Context Pools Store 121, and/or the Product Context Pools Store 122 using a User Persona Preprocessing Orchestration Agent 310 and one or more User Feature Extraction Agents 311. The obtained information may be used with a User Persona Synthesis Agent 320 to generate user personas. The generated user personas may be validated and augmented by a User Persona Refinement & Validation Agent 330 before being saved in the User Personas Store 131 for further use by the Computer System 110. A more detailed example of the User Persona Synthesis Subsystem 130 will be described with reference to FIG. 3.

The one or more User Persona Preprocessing Orchestration Agents 310 may refer to an agent that implements a single model from the set of the one or more Large Language Models 113. The User Persona Preprocessing Orchestration Agent 310 may be responsible for delegating tasks to the one or more User Feature Extraction Agents 311. The one or more User Feature Extraction Agents 311 may refer to multiple implementations of one or more User Feature Extraction Agents 312A-N, which may refer to a large language model agent tasked to extract specific user features from structured and unstructured data.

The User Persona Synthesis Agent 320 may be an agent based on a specifically trained large language model from the set of the one or more Large Language Models 113 tasked to take the outputs from the one or more User Persona Preprocessing Orchestration Agents 310 and synthesize cohesive user personas. The User Persona Synthesis Agent 320 assesses and integrates the diverse information, identifying core characteristics, needs, and/or behaviors that define the target audience segments.

The User Persona Refinement & Validation Agent 330 may be an agent based on a specifically trained large language model from the set of Large Language Models 113 tasked to carry out a process that incorporates direct client feedback, prior campaign data, and user testing to refine the generated user personas. Direct client feedback is facilitated through the one or more Client-Interfacing Systems 105. This interactive step ensures the personas remain accurate and relevant across different marketing campaigns. If a user persona is successfully validated, the structured data that defines the generated user persona is stored in the User Personas Store 131. The User Personas Store 131 may refer to a data store that contains structured and/or unstructured data as it relates to the user personas generated by the Computer System 110.

### Problem/Insight Identification and Validation Subsystem

Identifying a specific problem that the target audience faces is an important part of creating a marketing concept for an individual, company, or brand. This problem often relates to a gap in the market, an unmet need, or a pain point with current solutions. Through comprehensive market research and analysis, companies can pinpoint the exact nature of these issues, thereby informing the direction of their marketing strategies. Problem identification is pivotal as it ensures the marketing concept is grounded in real, tangible consumer needs, making the subsequent solutions offered both relevant and compelling.

Identifying a specific insight into a problem is how an individual, company, or brand can set themselves apart from their competition. This insight often relates to a deep understanding of the distinctive qualities or advantages that an individual, company, or brand possesses, which differentiate them from their competitors and provide them with unique solutions to their challenges. This understanding helps in identifying and leveraging their unique selling propositions and competitive edge in their respective markets or problem-space.

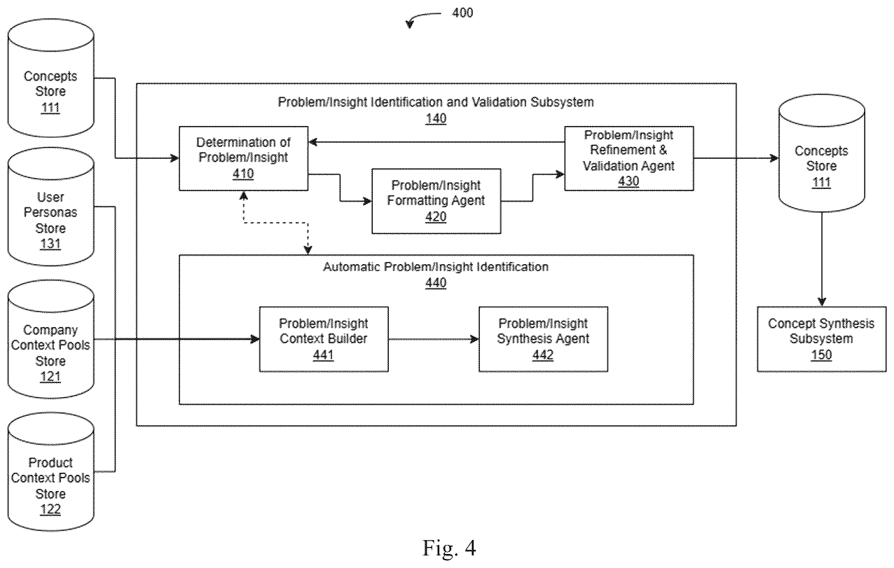

The Problem/Insight Identification and Validation Subsystem 140 may determine, produce, refine, validate, and store both the problem and insight, as described herein and as it relates to the goal for the concepts generated by the Computer System 110. For example, the Problem/Insight Identification and Validation Subsystem 140 may obtain information from the Concepts Store 111 for use in a Determination of Problem/Insight process 410. The Determination of Problem/Insight process 410 may use the customer-provided problem, client-provided insight, and/or other structured data points stored in the Concepts Store 111 to determine if the Problem/Insight Identification and Validation Subsystem 140 shall generate a new problem and/or insight with an Automatic Problem/Insight Identification process 440, use the existing client-provided problem and/or insight, or user another means of retrieving a problem and/or insight. Once the Determination of Problem/Insight process 410 has a value for problem and/or insight, it may instruct a Problem/Insight Formatting Agent 420 to format the problem and/or insight into a structured format for use with other components of the Computer System 110. The generated structured format of the problem and/or insight may be validated and augmented by a Problem/Insight Refinement & Validation Agent 430 before being saved in the Concepts Store 111 for further use by the Computer System 110. A more detailed example of the Problem/Insight Identification and Validation Subsystem 130 will be described with reference to FIG. 4.

The Automatic Problem/Insight Identification process 440 may define a process using a Problem/Insight Context Builder 441 and a Problem/Insight Synthesis Agent 442 to automatically generate the problem and/or insight. The Problem/Insight Context Builder 441 may obtain information from the Company Context Pools Store 121, and/or the Product Context Pools Store 122 to build structured, natural language context to support the Problem/Insight Synthesis Agent 442.

The Problem/Insight Synthesis Agent 442 may be an agent based on a specifically trained large language model from the set of the one or more Large Language Models 113 tasked to utilize the context generated by the Problem/Insight Context Builder 441 to synthesize a problem and/or insight in natural language. The Problem/Insight Synthesis Agent 442 assesses and integrates context from the various data sources, identifying relationships between the user needs and/or behaviors that define the target audience segments and the business goals.

The Problem/Insight Refinement & Validation Agent 430 may be an agent based on a specifically trained large language model from the set of Large Language Models 113 tasked to carry out a process that incorporates direct client feedback, prior campaign data, and user testing to refine the formatted problem and/or insight. Direct client feedback is facilitated through the one or more Client-Interfacing Systems 105. This interactive step ensures the problem and/or insight remain accurate and relevant across different marketing campaigns. If a formatted problem and/or insight is successfully validated, the structured data that defines the formatted problem and/or insight is stored in the Concepts Store 111, as described herein.

### Concept Synthesis Subsystem

A marketing concept is an innovative and strategic approach designed to effectively communicate a brand, product, or service to its target audience in a manner that is both engaging and persuasive. This concept revolves around a central idea that differentiates the campaign from competitors and resonates with the target audience, ultimately driving them towards a desired action or perception change. The development of a creative marketing concept involves a meticulous process that integrates the understanding of user personas, identification of problems, derivation of insights, and the application of an appropriate tone. Each component plays a crucial role in the creation of a marketing strategy that is not only creative but also impactful and aligned with the client brand's objectives.

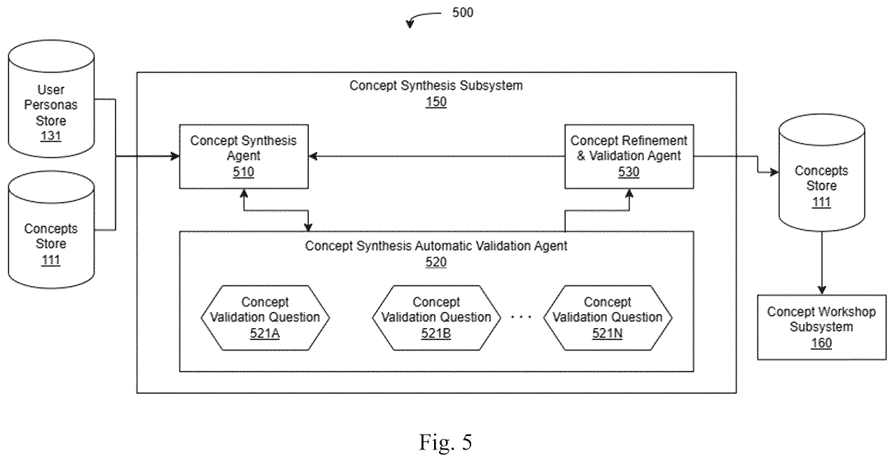

The Concept Synthesis Subsystem 150 may determine, produce, refine, validate, and store the concepts generated for further use by the Computer System 110. For example, the Concept Synthesis Subsystem 150 may obtain information from the Concepts Store 111 and/or the User Personas Store 131 for use in a Concept Synthesis Agent 510. The Concept Synthesis Agent 510 may use the user persona, problem, insight, and/or other data points found in the Concepts Store 111 and/or the User Personas Store 131 to synthesize concepts in a structured form as described herein. The concepts generated by the Concept Synthesis Agent 510 may be validated and augmented by a Concept Synthesis Automatic Validation Agent 520 and by a Concept Refinement & Validation Agent 530 before being saved in the Concepts Store 111 for further use by the Computer System 110. A more detailed example of the Concept Synthesis Subsystem 150 will be described with reference to FIG. 5.

The Concept Synthesis Agent 510 may be an agent based on a specifically trained large language model from the set of the one or more Large Language Models 113 tasked to utilize data stored in the Concepts Store 111 and/or the User Personas Store 131 to synthesize a structured data model reflective of a concept as described herein.

The Concept Synthesis Automatic Validation Agent 520 may be an agent based on a specifically trained large language model from the set of the one or more Large Language Models 113 tasked to answer a series of questions, shown in FIG. 5 as Concept Validation Questions 521A-N. The agent may be tasked to impersonate the client-selected user persona prior to answering the questions, such that the questions are answered in a way that reflects how the user persona would answer such questions. These questions shall be answered by the Concept Synthesis Automatic Validation Agent 520 with only yes/no answers. The total score of these questions shall be used to determine if a concept should be passed to the Concept Refinement & Validation Agent 530, or if a new concept shall be requested by the Concept Synthesis Automatic Validation Agent 520.

The Concept Refinement & Validation Agent 530 may be an agent based on a specifically trained large language model from the set of Large Language Models 113 tasked to carry out a process that incorporates direct client feedback, prior campaign data, and user testing to refine the structured concept, as described herein. Direct client feedback is facilitated through the one or more Client-Interfacing Systems 105. This interactive step ensures the concept remains accurate and relevant across different marketing campaigns. If a concept is successfully validated, the structured data that defines the concept is stored in the Concepts Store 111, as described herein.

### Concept Workshop Subsystem

Once a concept has been generated to a client's satisfaction, there may be additional modifications needed to make the concept become elevated and additional metadata that can be defined for the concept. This process is different from the Concept Refinement & Validation Agent 530 of the Concept Synthesis Subsystem 150, as this process is meant to elaborate on and/or selectively augment components of a client-selected concept.

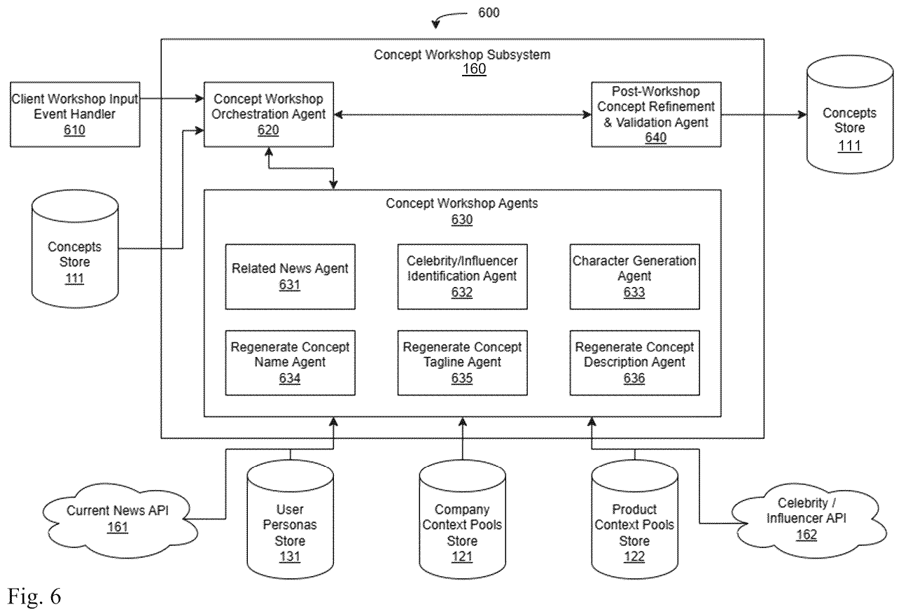

The Concept Workshop Subsystem 160 may further define, enhance, refine, validate, and store the augment concepts generated by the computer system 110. For example, the Concept Workshop Subsystem 160 may accept a client-interfacing event generated by a Client Workshop Input Event Handler 610, which may generate events that describe interactions a client may take as captured by any number of the one or more Client-Interfacing Systems 105. In response to an event from the Client Workshop Input Event Handler 610, the Concept Workshop Subsystem 160 may obtain information from the Concepts Store 111 for use with a Concept Workshop Orchestration Agent 620. The results of the Concept Workshop Orchestration Agent 620 may be validated and augmented by a Post-Workshop Concept Refinement & Validation Agent 640 before being saved to the Concepts Store 111 for further use by the Computer System 110. A more detailed example of the Concept Workshop Subsystem 160 will be described with reference to FIG. 6.

The Concept Workshop Orchestration Agent 620 may be an agent based on a specifically trained large language model from the set of the one or more Large Language Models 113 tasked to utilize data stored in the Concepts Store 111 and/or the User Personas Store 131 to synthesize a structured data model reflective of a concept as described herein.

The Concept Workshop Orchestration Agent 620 may refer to an agent that implements a single model from the set of the one or more Large Language Models 113. The Concept Workshop Orchestration Agent 620 may be responsible for delegating N number of tasks to one or more Concept Workshop Agents 630. The one or more Concept Workshop Agents 630 may refer to multiple agents that implement a single model from the set of the one or more Large Language Models 113 and may include, but not be limited to, a Related News Agent 631, a Celebrity/Influencer Identification Agent 632, a Character Generation Agent 633, a Regenerate Concept Name Agent 634, a Regenerate Concept Tagline Agent 635, and/or a Regenerate Concept Description Agent 636.

The Related News Agent 631 may be referred to as an agent that implements a large language model from the set of the one or more Large Language Models 113. The Related News Agent 631 may be responsible for fetching data from a Current News API 161 based on relevant data found in the Concepts Store 111, the Company Context Pools Store 121, the Product Context Pools Store 122, and/or the User Personas Store 131. The Current News API 161 is an application programming interface (API) that allows for the Computer System 110 to communicate with other computer systems to fetch data related to current news articles.

The Celebrity/Influencer Identification Agent 632 may be referred to as an agent that implements a large language model from the set of the one or more Large Language Models 113. The Celebrity/Influencer Identification Agent 632 may be responsible for fetching data from a Celebrity/Influencer API 162 based on relevant data found in the Concepts Store 111, the Company Context Pools Store 121, the Product Context Pools Store 122, and/or the User Personas Store 131 The Celebrity/Influencer API 162 is an application programming interface (API) that allows for the Computer System 110 to communicate with other computer systems to fetch data related to celebrities and/or influencers.

The Character Generation Agent 633 may be referred to as an agent that implements a large language model from the set of the one or more Large Language Models 113. The Character Generation Agent 633 may be responsible for creating creative character personas that are based on relevant data found in the Concepts Store 111, the Company Context Pools Store 121, the Product Context Pools Store 122, and/or the User Personas Store 131.

The Regenerate Concept Name Agent 634 may be referred to as an agent that implements a large language model from the set of the one or more Large Language Models 113. The Regenerate Concept Name Agent 634 may be responsible for recreating a concept name, as defined herein, that is based on relevant data found in the Concepts Store 111, the Company Context Pools Store 121, the Product Context Pools Store 122, and/or the User Personas Store 131.

The Regenerate Concept Tagline Agent 635 may be referred to as an agent that implements a large language model from the set of the one or more Large Language Models 113. The Regenerate Concept Tagline Agent 635 may be responsible for recreating a concept tagline, as defined herein, that is based on relevant data found in the Concepts Store 111, the Company Context Pools Store 121, the Product Context Pools Store 122, and/or the User Personas Store 131.

The Regenerate Concept Description Agent 636 may be referred to as an agent that implements a large language model from the set of the one or more Large Language Models 113. The Regenerate Concept Description Agent 636 may be responsible for recreating a concept description, as defined herein, that is based on relevant data found in the Concepts Store 111, the Company Context Pools Store 121, the Product Context Pools Store 122, and/or the User Personas Store 131.

The Post-Workshop Concept Refinement & Validation Agent 640 may be an agent based on a specifically trained large language model from the set of Large Language Models 113 tasked to carry out a process that incorporates direct client feedback, prior campaign data, and user testing to refine the structured concept, as described herein. Direct client feedback is facilitated through Client-Interfacing Systems 105. This interactive step ensures the concept remains accurate and relevant across different marketing campaigns. If a concept is successfully validated, the structured data that defines the concept is stored in the Concepts Store 111, as described herein.

The computer system 110 and the one or more Client-Interfacing Systems 105 may be connected to one another via a communication network (not illustrated), such as the Internet or the Internet in combination with various other networks, like local area networks, cellular networks, or personal area networks, internal organizational networks, and/or other networks. It should be noted that the computer system 110 may transmit data, via the communication network, conveying the predictions to one or more of the one or more Client-Interfacing Systems 105. The data conveying the predictions may be a user interface generated for display at the one or more Client-Interfacing Systems 105, one or more messages transmitted to the one or more Client-Interfacing Systems 105, and/or other types of data for transmission. Although not shown, the one or more Client-Interfacing Systems 105 may each include one or more processors.

Each of the Computer System 110 and the one or more Client-Interfacing Systems 105 may also include memory in the form of electronic storage. The electronic storage may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storage may store software algorithms, information determined by the processors, information obtained from servers, information obtained from client devices, or other information that enables the functionalities described herein.

### Subsystem Workflow

The Data Ingestion Subsystem 120 works to find and take data from multiple different sources, organizes that data, and sends it to the rest of the system for use in the various subsystems. In one embodiment of this invention, the Data Ingestion Subsystem 120 uses the one or more Data Extraction Agents 211 to find and extract data from many different sources, including but not limited to the at least one Client-Provided Structured Data Source 101, the at least one Client-Provided Unstructured Data Source 102, the Unstructured Internet Data set 103, and the one or more Marketing Databases 104. The one or more Data Extraction Agents 211, which include the Core Client Data Agent 212, the Web Scraper Agent 213, and the Marketing Database Agent 214, actively and constantly scour both internal and external databases, as well as the internet, for data that could be useful to the system. The data extracted from these and other sources is processed by the Data Extraction Orchestration Agent 210, and then is sent to the User Persona Synthesis Subsystem 130 to aid in the creation of user personas. The Data Extraction Orchestration Agent 210 also sends the extracted data and stores it in the Concepts Store 111, the Company Context Pools Store 121, and the Product Context Pools Store 122.

Once receiving the extracted data from the Data Extraction Orchestration Agent 210 via the Concepts Store 111, the Company Context Pools Store 121, and the Product Context Pools Store 122, the User Persona Synthesis Subsystem 130 uses the data to create user personas. These user personas serve as a baseline for the system to create advertisement strategies targeting certain demographics or groups. In one embodiment of the invention, to accomplish this goal, the User Persona Preprocessing Orchestration Agent 310 prepares data it extracts from the Concepts Store 111 for use by the one or more User Feature Extraction Agents 311 and the User Persona Synthesis Agent 320. The one or more User Feature Extraction Agents 311 takes the data received from the User Persona Preprocessing Orchestration Agent 310, as well as data from the Company Context Pools Store 121 and the Product Context Pools Store 122 and uses multiple implementations of the one or more User Feature Extraction Agents 312A-N, which are large language model agents tasked to extract specific user features from structured and unstructured data. Once the one or more User Feature Extraction Agents 312A-N extract specific user features from the received data, it sends these specific user features back to the User Persona Preprocessing Orchestration Agent 310 for preparation to send to the User Persona Synthesis Agent 320. The User Persona Synthesis Agent 320 assesses and integrates these specific user features, identifying core characteristics, needs, and/or behaviors that define the target audience segments into user personas. The User Persona Synthesis Agent 320 sends these user personas to the User Persona Refinement & Validation Agent 330 for refinement and validation. The User Persona Refinement & Validation Agent 330 is a process that incorporates direct client feedback, prior campaign data, and user testing to refine the generated user personas from the User Persona Synthesis Agent 320. If the User Persona Refinement & Validation Agent 330 determines that these user personas are ready for use by the rest of the system, the User Persona Refinement & Validation Agent 330 will send these user personas to the User Personas Store 131. If the User Persona Refinement & Validation Agent 330 determines that there are inadequacies, inconsistencies, or other issues with a user persona, it will send it back to the User Persona Preprocessing Orchestration Agent 310 to go through the process of data and feature extraction again to remedy the issue.

Once these user personas are placed into the User Personas Store 131 by the User Persona Refinement & Validation Agent 330, they are used in the Problem/Insight Identification and Validation Subsystem 140 to create/find insights into problems facing a given group or demographic. The Automatic Problem/Insight Identification process 440 extracts information from the Company Context Pools Store 121, the Product Context Pools Store 122, and the User Personas Store 131 using the Problem/Insight Context Builder 441. The Problem/Insight Context Builder 441 uses the information extracted from the Company Context Pools Store 121, the Product Context Pools Store 122, and the User Personas Store 131 to glean the context surrounding problems and/or insights into those problems. The Problem/Insight Synthesis Agent 442 uses the data extracted from the Company Context Pools Store 121, the Product Context Pools Store 122, and the User Personas Store 131, along with the context gleaned by the Problem/Insight Context Builder 441, to synthesize problems and/or insights into those problems in natural language. The Determination of Problem/Insight process 410 uses these synthesized problems and/or insights into those problems created by the Problem/Insight Synthesis Agent 442, along with data extracted from the Concepts Store 111, to determine a problem, problems, insight, or insights into a specific problem or problems for a specific group or demographic. Once a problem, problems, insight, or insights into a specific problem is determined, the Determination of Problem/Insight process 410 sends them to the Problem/Insight Formatting Agent 420 to format the problem and/or insight into a structured format for use with other components of the system. The Problem/Insight Formatting Agent 420 sends these problems and/or insights to the Problem/Insight Refinement & Validation Agent 430 for refinement and validation. The Problem/Insight Refinement & Validation Agent 430 incorporates direct client feedback, prior campaign data, and user testing to refine the formatted problem and/or insight for use by the rest of the system. If the Problem/Insight Refinement & Validation Agent 430 determines that these insights/problems are ready for use by the rest of the system, the Problem/Insight Refinement & Validation Agent 430 will send these insights/problems to the Concepts Store 111. If the Problem/Insight Refinement & Validation Agent 430 determines that there are inadequacies, inconsistencies, or other issues with an insight/problem, it will send it back to the Determination of Problem/Insight process 410 to go through the process of data, persona, and context extraction again to remedy the issue.

Once these insights/problems are stored in the Concepts Store 111 by the Problem/Insight Refinement & Validation Agent 430, they are used by the Concept Synthesis Subsystem 150 to create a concept or concepts for an advertisement or campaign based on those insights/problems. To accomplish this goal, the Concept Synthesis Subsystem 150 utilizes the Concept Synthesis Agent 510 to synthesize a concept or concepts. The Concept Synthesis Agent 510 extracts user personas, problems, insights, and/or other data points from the Concepts Store 111 and/or the User Personas Store 131 to synthesize concepts in a structured form. Once these concepts are synthesized in a structured form, they are sent to the Concept Synthesis Automatic Validation Agent 520 for testing. The Concept Synthesis Automatic Validation Agent 520 uses the concepts it received from the Concept Synthesis Agent 510 to answer a series of questions, shown as Concept Validation Questions 521A-N. The Concept Synthesis Automatic Validation Agent 520 impersonates the client-selected user persona prior to answering the questions, such that the questions are answered in a way that reflects how the user persona would answer such questions. These questions shall be answered by the Concept Synthesis Automatic Validation Agent 520 with only yes/no answers. The total score of these questions shall be used to determine if a concept should be passed to the Concept Refinement & Validation Agent 530, or if a new concept shall be requested by the Concept Synthesis Automatic Validation Agent 520. The Concept Refinement & Validation Agent 530 incorporates direct client feedback, prior campaign data, and user testing to refine the formatted concept for use by the rest of the system. If the Concept Refinement & Validation Agent 530 determines that these concepts are ready for use by the rest of the system, the Concept Refinement & Validation Agent 530 will send these concepts to the Concepts Store 111. If the Concept Refinement & Validation Agent 530 determines that there are inadequacies, inconsistencies, or other issues with concept, it will send it back to the Concept Synthesis Agent 510 to go through the process of concept synthesis again to remedy the issue.

Once these concepts are stored in the Concepts Store 111 by the Concept Refinement & Validation Agent 530, they are used by the Concept Workshop Subsystem 160 to turn the concepts into specific advertisement/campaign ideas. When the Concept Workshop Subsystem 160 receives a client-interfacing event generated by the Client Workshop Input Event Handler 610, the Concept Workshop Subsystem 160 uses the Concept Workshop Orchestration Agent 620 to orchestrate the concept into a concept that the user can apply using information from the client-interfacing event, along with data extracted from the Concepts Store 111 regarding concepts created by the Concept Synthesis Subsystem 150. The Concept Workshop Orchestration Agent 620 works with the one or more Concept Workshop Agents 630 to create working concepts for advertisements and campaigns. The one or more Concept Workshop Agents 630 uses multiple agents that include, but are not limited to, the Related News Agent 631, the Celebrity/Influencer Identification Agent 632, the Character Generation Agent 633, the Regenerate Concept Name Agent 634, the Regenerate Concept Tagline Agent 635, and/or the Regenerate Concept Description Agent 636. The one or more Concept Workshop Agents 630 also extract data from the Company Context Pools Store 121, the Product Context Pools Store 122, the User Personas Store 131, the Current News API 161, and the Celebrity/Influencer API 162 to augment and develop working concepts for an advertisement or campaign directed at a specific problem facing a specific group or demographic. Once the one or more Concept Workshop Agents 630 have created a working concept for an advertisement or campaign directed at a specific problem facing a specific group or demographic, it is sent to the Post-Workshop Concept Refinement & Validation Agent 640 for refinement. Once the Post-Workshop Concept Refinement & Validation Agent 640 has refined the working concept for an advertisement or campaign directed at a specific problem facing a specific group or demographic, it is stored in the Concepts Store 111 for use by the user to complete the creation of an advertisement or campaign.

The databases and data stores (such as the Concepts Store 111, the Company Context Pools Store 121, the Product Context Pools Store 122, and the User Personas Store 131) may be, include, or interface to, for example, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof. The systems and processes are not limited to the specific implementations described herein. In addition, components of each system and each process can be practiced independent and separate from other components and processes described herein. Each component and process also can be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system features illustrated in FIG. 1.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Having thus described the invention, it is now claimed:

I/We claim:

1. A method for generating marketing concepts comprising the steps of:
(a) extracting data from at least one of the following: a client-provided structured data source, a client-provided unstructured data source, internet data, and a marketing database;
(b) storing the extracted data of step (a) in at least one of the following: a concepts store, a company context pools store, and a product context pools store;
(c) creating a user persona based on the stored data of step (b), wherein the user persona represents traits of a segment of a target audience of the marketing concepts;
(d) identifying a problem faced by the segment of the target audience represented by the user persona of step (c); and
(e) creating a marketing concept based on the identified problem of step (d); wherein:
steps (a)-(e) are performed by a computer system comprising one or more computers; and
at least a portion of each of steps (a)-(e) is performed by at least one LLM agent running on the computer system.

2. The method of claim 1, wherein:
the user persona created in step (c) is stored in a user personas store;
the problem identified in step (d) is stored in the concepts store; and
the marketing concept created in step (e) is stored in the concepts store.

3. The method of claim 2, wherein:
step (d) further comprises identifying insight into the identified problem of step (d); and
the identified insight is stored in the concepts store.

4. The method of claim 3, wherein:
at least a portion of step (a) is performed by one or more data extraction LLM agents
at least a portion of step (b) is performed by a data extraction orchestration LLM agent; and
the data extraction orchestration LLM agent delegates at least a portion of step (a) to the one or more data extraction LLM agents.

5. The method of claim 4, wherein:
the one or more data extraction LLM agents comprise a core client data LLM agent, a web scraper LLM agent, and a marketing database LLM agent;
the core client data LLM agent extracts data from the client-provided structured data source or the client-provided unstructured data source in step (a);
the web scraper LLM agent extracts data from the internet data in step (a); and
the marketing database LLM agent extracts data from the marketing database in step (a).

6. The method of claim 3, wherein step (c) comprises steps:
(f) retrieving and analyzing the stored data of step (b) from the company context pools store or the product context pools store to extract traits for the user persona; and
(g) synthesizing the extracted traits of step (f) into the user persona; wherein:
at least a portion of step (f) is performed by one or more user feature extraction LLM agents; and
at least a portion of step (g) is performed by a user persona synthesis LLM agent.

7. The method of claim 3, wherein step (d) comprises steps:
(h) retrieving data from the user personas store, the company context pools store, or the product context pools store and building context for the problem or the insight of step (d) using structured, natural language; and
(i) using the context built in step (h) to synthesize the problem or the insight in natural language;
wherein at least a portion of step (i) is performed by a problem/insight synthesis LLM agent.

8. The method of claim 7, wherein step (d) further comprises step:
(j) using feedback from a user of the computer system or prior marketing campaign data to refine the problem or the insight of step (i),
wherein the refined problem or insight is stored in the concepts store.

9. The method of claim 3, wherein step (e) comprises steps:
(k) retrieving data from the concepts store or the user personas store; and
(l) using the retrieved data of step (k) to synthesize the marketing concept of step (e) in a structured data model,
wherein at least a portion of step (l) is performed by a concept synthesis LLM agent.

10. The method of claim 9, wherein step (e) further comprises step:
(m) validating the marketing concept synthesized in step (l),
wherein at least a portion of step (m) is performed by a concept synthesis automatic validation LLM agent, and wherein step (m) comprises steps:
(n) impersonating a retrieved user persona by the concept synthesis automatic validation LLM agent;
(o) answering a plurality of questions about the marketing concept synthesized in step (l) from a perspective of the impersonated user persona of step (n) by the concept synthesis automatic validation LLM agent, where the plurality of questions are in a form that have only “yes” or “no” answers and are used to predict a success rate of the marketing concept being validated; and
(p) using a total score of the answered questions of step (o) to determine whether to validate the marketing concept synthesized in step (l).

11. The method of claim 9, wherein step (e) further comprises step:
(q) using feedback from a user of the computer system or prior marketing campaign data to refine the marketing concept synthesized in step (l),
wherein the refined marketing concept is stored in the concepts store.

12. The method of claim 3 further comprising step:
(r) augmenting the marketing concept created in step (e), wherein:
at least a portion of step (r) is performed by one or more concept workshop LLM agents; and
the augmented marketing concept of step (r) is stored in the concepts store.

13. The method of claim 12, wherein the one or more concept workshop LLM agents comprise a related news LLM agent, a celebrity/influencer identification LLM agent, a character generation LLM agent, a regenerate concept name LLM agent, a regenerate concept tagline LLM agent, or a regenerate concept description LLM agent.

14. A method for generating marketing concepts comprising the steps of:
(a) extracting data from at least one of the following using one or more data extraction LLM agents: a client-provided structured data source, a client-provided unstructured data source, internet data, and a marketing database;
(b) storing the extracted data of step (a) in at least one of the following: a concepts store, a company context pools store, and a product context pools store;
(c) analyzing the stored data of step (b) to extract a plurality of traits for a segment of a target audience of the marketing concepts using one or more user feature extraction LLM agents;
(d) synthesizing the extracted traits of step (c) into a user persona that represents the segment of the target audience of the marketing concepts using a user persona synthesis LLM agent, and storing the user persona in a user personas store;
(e) using the stored data of step (b) or the stored user persona of step (d) to build context for a problem faced by the segment of the target audience represented by the user persona or insight into the problem using structured, natural language;
(f) using the context built in step (e) to synthesize the problem or the insight in natural language using a problem/insight synthesis LLM agent, and storing the synthesized problem or insight in the concepts store; and
(g) using the synthesized problem or insight of step (f) to synthesize a marketing concept in a structured data model using a concept synthesis LLM agent, and storing the marketing concept in the concepts store;
wherein steps (a)-(g) are performed by a computer system comprising one or more computers.

15. The method of claim 14, further comprising step:
(h) using feedback from a user of the computer system or prior marketing campaign data to refine the user persona of step (d), the problem or the insight of step (f), or the marketing concept of step (g),
wherein step (h) is performed by the computer system.

16. The method of claim 14, further comprising steps:
(i) impersonating a user persona of step (d) by a concept synthesis automatic validation LLM agent;
(j) answering a plurality of questions about the marketing concept synthesized in step (g) from a perspective of the impersonated user persona of step (i) by the concept synthesis automatic validation LLM agent, where the plurality of questions are in a form that have only “yes” or “no” answers and are used to predict a success rate of the marketing concept; and
(k) using a total score of the answered questions of step (j) to determine whether to validate the marketing concept synthesized in step (g),
wherein steps (i)-(k) are performed by the computer system.

17. The method of claim 14, further comprising step:
(l) augmenting the marketing concept synthesized in step (g) using one or more concept workshop LLM agents comprising a related news LLM agent, a celebrity/influencer identification LLM agent, a character generation LLM agent, a regenerate concept name LLM agent, a regenerate concept tagline LLM agent, or a regenerate concept description LLM agent,
wherein step (l) is performed by the computer system.

18. A system for generating marketing concepts comprising:
at least one computer running at least one LLM agent; wherein
the at least one computer is programmed to execute steps (a)-(e) of claim 1; and
at least a portion of each of steps (a)-(e) of claim 1 is performed by the at least one LLM agent.

19. A system for generating marketing concepts comprising:
a computer system, including at least one computer, comprising:
a data ingestion subsystem comprising one or more data extraction LLM agents;
a user persona synthesis subsystem comprising one or more user feature extraction LLM agents and a user persona synthesis LLM agent;
a problem/insight identification and validation subsystem comprising a problem/insight synthesis LLM agent; and
a concept synthesis subsystem comprising a concept synthesis LLM agent; wherein:
the data ingestion system executes steps (a)-(b) of claim 14;
the user persona synthesis subsystem executes steps (c)-(d) of claim 14;
the problem/insight identification and validation subsystem executes steps (e)-(f) of claim 14; and
the concept synthesis subsystem executes step (g) of claim 14.

20. A non-transitory computer-readable medium comprising instructions for causing a computer system to perform the method of claim 1.
